(19) United States
(12) Patent Application Publication
(10) Pub. No.: US 2024/0085603 A1
(43) Pub. Date: Mar. 14, 2024

(54) PRISM AND OPTICAL SYSTEM INCLUDING THE SAME

(71) Applicant: SAMSUNG ELECTRONICS CO., LTD., Suwon-si (KR)

(72) Inventor: Seonghyun YOO, Suwon-si (KR)

(21) Appl. No.: 18/209,632

(22) Filed: Jun. 14, 2023

(30) Foreign Application Priority Data
Sep. 5, 2022 (KR) 10-2022-0112377

(51) Int. Cl. G02B 5/20; G02B 5/00; G02B 5/04

(52) U.S. Cl. CPC G02B 5/208; G02B 5/003; G02B 5/04

(57) ABSTRACT

A prism includes an incident face on which incident light including visible light and infrared is incident, a reflective face from which at least a part of incident light is reflected, and an exit face from which reflected light is emitted. Visible light of incident light is totally reflected from the reflective face, and only a part of infrared of incident light is totally reflected from the reflective face.

### CROSS-REFERENCE TO RELATED APPLICATION

This application is based on and claims priority under 35 U.S.C. § 119 to Korean Patent Application No. 10-2022-0112377, filed on Sep. 5, 2022, in the Korean Intellectual Property Office, the disclosure of which is incorporated by reference herein in its entirety.

### BACKGROUND

### 1. Field

Embodiments relate to a prism and an optical system including the same, and more particularly, to a prism on which visible light and infrared are incident and an optical system including the same.

### 2. Description of the Related Art

Image sensors capturing objects and converting the objects into electrical signals are widely used in cameras mounted in vehicles, security devices, and robots as well as electronic devices for general users, e.g., digital cameras, mobile phone cameras, and camcorders. In accordance with the rapid development of the electronics industry and demands of users, electronic devices are becoming smaller and lighter. An electronic device may receive external light through an optical system. The received external light may be incident on an image sensor of the electronic device. The image sensor may include, e.g., an image sensor semiconductor chip. The image semiconductor chip may be, e.g., a complementary metal-oxide-semiconductor (CMOS) image sensor (CIS) or a charge-coupled device (CCD). In addition, the image sensor may include a cover glass to filter a wavelength of a specific band. The cover glass may include an infrared cut-off filter (IRCF) and/or a blue glass (or a blue filter) for an infrared filter.

### SUMMARY

According to an aspect of embodiments, there is provided a prism including an incident face on which incident light including visible light and infrared is incident, a reflective face from which at least a part of incident light is reflected, and an exit face from which reflected light is emitted. Visible light of incident light is totally reflected from the reflective face, and only a part of infrared of incident light is totally reflected from the reflective face.

According to another aspect of embodiments, there is provided an optical system including a prism including a top surface, a bottom surface, an incident face on which incident light including visible light and infrared is incident, a reflective face from which at least a part of incident light is reflected, and an exit face from which reflected light is emitted and a coating layer arranged outside the prism and in contact with the reflective face. Visible light of incident light is totally reflected from the reflective face, and only a part of infrared of incident light is totally reflected from the reflective face.

According to yet another aspect of embodiments, there is provided an optical system including a prism including a top surface, a bottom surface, an incident face on which incident light including visible light and infrared is incident, a reflective face from which at least a part of incident light is reflected, and an exit face from which reflected light is emitted, a first lens group including at least one lens with positive refractive power or at least one lens with negative refractive power and configured to direct light of a light source to the prism, and a second lens group, on which light reflected from the prism is incident, including at least one lens with positive refractive power or at least one lens with negative refractive power, and configured to direct reflected light to a light receiving system. Visible light of incident light is totally reflected from the reflective face, and only a part of infrared of incident light is totally reflected from the reflective face.

### BRIEF DESCRIPTION OF THE DRAWINGS

Features will become apparent to those of skill in the art by describing in detail exemplary embodiments with reference to the attached drawings, in which:

FIG. 1A is a plan view illustrating a prism according to an embodiment;

FIG. 1B is a perspective view illustrating the prism of FIG. 1A;

FIG. 2A is a plan view illustrating an optical system according to an embodiment;

FIG. 2B is a perspective view illustrating the optical system of FIG. 2A;

FIGS. 3A to 3C are views describing a law of total internal reflection according to an embodiment;

FIG. 4 is a schematic planar view illustrating an optical system according to an embodiment;

FIG. 5 is a schematic planar view illustrating an optical system according to an embodiment;

FIG. 6 is a block diagram of an electronic device including a multi-camera module;

FIG. 7 is a detailed block diagram of the multi-camera module of FIG. 6; and

FIG. 8 is a block diagram illustrating a configuration of an image sensor according to an embodiment.

### DETAILED DESCRIPTION

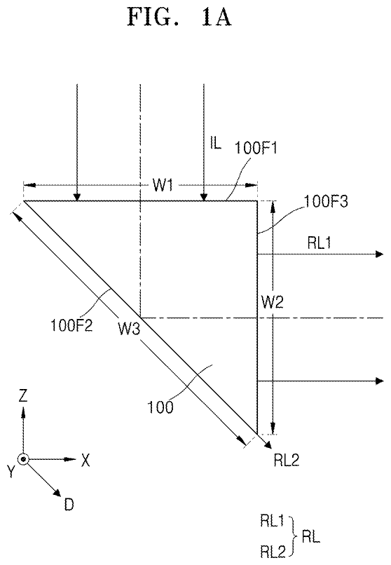

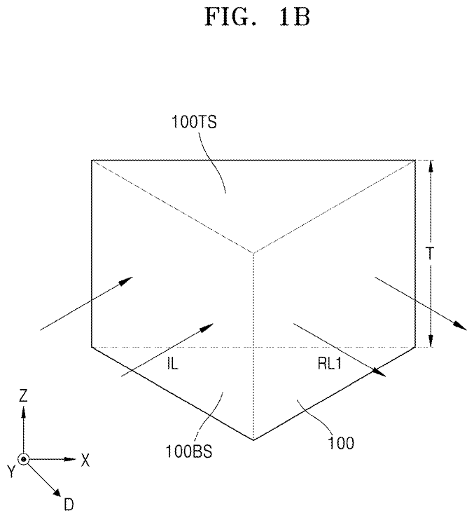

FIG. 1A is a plan view illustrating a top view of a prism 100 according to an embodiment, and FIG. 1B is a perspective view illustrating the prism 100 according to an embodiment. In FIGS. 1A and 1B, directions of movement of light are marked with arrows.

Referring to FIGS. 1A and 1B, the prism 100 may scatter incident light IL while changing a path of the incident light IL. For example, the prism 100 may be arranged in a folded optical system to change the path of the incident light IL through reflection and to make reflected light RL reflected from the prism 100 to be incident on an image sensor. In the folded optical system, a direction of the incident light IL and a direction of the reflected light RL may form about 90°.

For example, the prism 100 may be approximately in the form of a triangular pillar. For example, the prism 100 may be in the form of a triangular pillar with an isosceles triangle as a base. According to an embodiment, the prism 100 may be approximately in the form of a diagonally bisected rectangular parallelepiped or a diagonally bisected cube. For example, the prism 100 may include three rectangular faces and two triangular faces. For example, an incident face 100F1, a reflective face 100F2, and an exit face 100F3 of the prism 100 may be rectangular, and a top face 100TS and a bottom face 100BS (e.g., a bottom surface) of the prism 100 may be triangular. The rectangular faces of the prism 100 may include one or more long sides having a long edge in contact with the top face 100TS of the prism 100, and one or more short sides having a short edge in contact with the top face 100TS of the prism 100. For example, as illustrated in FIG. 1A, the reflective face 100F2 may have a long side (e.g., a long edge) in contact with the top face of the prism 100, and each of the incident face 100F1 and the exit face 100F3 may have a short side (e.g., a short edge) in contact with the top face of the prism 100.

In the current specification, a main face of the prism 100 may be defined as a horizontal direction (an X direction and/or a Z direction), and a direction perpendicular to the horizontal direction (the X direction and/or the Z direction) may be defined as a vertical direction (a Y direction). A direction in which the incident face 100F1 extends in the horizontal direction may be defined as a first direction (the X direction), and the horizontal direction perpendicular to the first direction (the X direction) may be defined as a second direction (the Z direction). A direction, in which an edge at which the reflective face 100F2 as the long side meets the top face 100TS of the prism 100 extends, may be defined as a third direction (a D direction).

In addition, in the current specification, the top face 100TS and the bottom face 100B S of the prism 100 may be defined as two faces spaced apart from each other in the vertical direction (the Y direction), and the top face 100TS of the prism 100 may be defined as a face with a large third direction (D direction) coordinate value. A thickness T of the prism 100 as a distance between the top face 100TS of the prism 100 and the bottom face 100BS of the prism 100 in the vertical direction (the Y direction), may be about 3 mm to about 10 mm.

A first width W1 of the incident face 100F1 in the first direction (the X direction) and/or a second width W2 of the exit face 100F3 in the second direction (the Z direction), may be about 3 mm to about 10 mm. That is, the first width W1 of an edge at which the incident face 100F1 meets the top face 100TS in the first direction (the X direction) and/or the second width W2 of an edge at which the exit face 100F3 meets the top face 100TS in the second direction (the Z direction), may be about 3 mm to about 10 mm. In addition, the third width W3 of the reflective face 100F2 in the third direction (the D direction), may be about 4 mm to about 14 mm. That is, the third width W3 of an edge at which the reflective face 100F2 meets the top face 100TS in the third direction (the D direction) may be about 4 mm to about 14 mm.

The third width W3 may be greater than the first width W1 and the second width W2. As mentioned above, the top face 100TS and/or the bottom face 100BS of the prism 100 may be approximately in the form of a triangle. For example, the prism 100 may be in the form of an isosceles triangle with the same first and second widths W1 and W2. That is, the top face 100TS and/or the bottom face 100BS of the prism 100 may be in the form of an isosceles triangle. In another embodiment, in the prism 100, the first width W1 may be different from the second width W2.

The incident light IL may be incident on the prism 100 through one of a plurality of faces of the prism 100. The incident light IL may be incident on the incident face 100F1 of the prism 100. For example, referring to FIG. 1A, the incident face 100F1 of the prism 100 may be substantially orthogonal to the second direction (the Z direction). Therefore, light incident in the second direction (the Z direction) may pass through the incident face 100F1 without being refracted from the incident face 100F1 of the prism 100.

The incident light IL incident on the prism 100 through the incident face 100F1 may be reflected from the reflective face 100F2 as the long side (e.g., dashed line in FIG. 1A). An acute angle formed by the reflective face 100F2 (as the long side) and the incident face 100F1 (as the short side) and/or the exit face 100F3 may be a critical angle at which at least a part of the incident light IL causes total internal reflection. For example, the acute angle may be about 45°. Therefore, the reflective face 100F2 may be a total internal reflection face. That is, the reflective face 100F2 and the incident face 100F1 may form an angle of about 45°, and the reflective face 100F2 and the exit face 100F3 may form an angle of about 45°. In addition, the incident face 100F1 and the exit face 100F3 may form an angle of about 90°.

In the current specification, total internal reflection refers to a phenomenon in which about 90% or more of incident light is reflected. For example, total internal reflection may refer to a phenomenon in which about 95% or more of the incident light is reflected, e.g., about 99% or more of the incident light is reflected.

When each of an angle formed between the reflective face 100F2 (as the long side) and the incident face 100F1 (as the short side) and an angle formed between the reflective face 100F2 (as the long side) and the exit face 100F3 (as the short side) is about 45°, first reflected light RL1 may be generated to move parallel to the first direction (the X direction) so that a path of the first reflected light RL1 may be easily controlled. For example, when each of the angle formed between the reflective face 100F2 (as the long side) and the incident face 100F1 (as the short side) and an angle formed between the reflective face 100F2 (as the long side) and the exit face 100F3 (as the short side) is about 45°, the incident light IL and the first reflected light RL1 may form an angle of about 90°. Therefore, the path of the first reflected light RL1 may be easily controlled.

For example, the incident light IL may include visible light and infrared, e.g., infrared light or infrared waves. Visible light refers to light with a wavelength of about 400 nm to about 700 nm, and infrared refers to light with a wavelength of about 700 nm to about 300 μm. A part of the incident light IL may be totally reflected from the reflective face 100F2. For example, visible light may be totally reflected from the reflective face 100F2 to move in the first direction (the X direction). At least a part of the infrared may not be totally reflected from the reflective face 100F2, e.g., a part of the infrared may move in the third direction (the D direction). In another embodiment, at least a part of the infrared may not be totally reflected from the reflective face 100F2, e.g., a part of infrared may move in a direction different from the first direction (the X direction). For example, a first part of the infrared may be reflected from the reflective face 100F2, a second part of the infrared may pass through the reflective face 100F2, and a third part (i.e., a remaining part) of the infrared may move in the third direction (the D direction) and/or a direction different from the first direction (the X direction). Therefore, at least a part of the infrared may be separated at the reflective face 100F2.

The reflected light RL reflected from the reflective face 100F2 may include the first reflected light RL1 including visible light and infrared reflected from the reflective face 100F2 and second reflected light RL2 including, e.g., only, infrared reflected from the reflective face 100F2. The first reflected light RL1 may pass through the exit face 100F3. For example, the exit face 100F3 may be substantially orthogonal to the first direction (the X direction). Therefore, the first reflected light RL1 moving in the first direction (the X direction) may pass through the exit face 100F3 without being refracted from the exit face 100F3 of the prism 100. Because the second reflected light RL2 moves on, e.g., along, the reflective face 100F2 in the third direction (the D direction) and/or is reflected out of the prism 100 or passes through the prism 100, the second reflected light RL2 may not pass through the exit face 100F3 of the prism 100. For example, the second reflected light RL2 may move in a direction different from the first direction (the X direction). That is, the first reflected light RL1 and the second reflected light RL2 may move in different directions. Therefore, the incident light IL including visible light and infrared may pass through the prism 100 and may be split into the first reflected light RL1 including parts of visible light and infrared and the second reflected light RL2 including only infrared.

Therefore, a ratio of visible light included in the incident light IL may be less than a ratio of visible light included in the first reflected light RL1, e.g., a fraction of the visible light within the total incident light IL may be less than a fraction of the visible light in the first reflected light RL1. Therefore, when the incident light IL passes through the prism 100, the first reflected light RL1 including a higher ratio (e.g., fraction) of visible light may be generated. In addition, the ratio of visible light included in the first reflected light RL1 may be greater than that of visible light included in the second reflected light RL2.

In other words, a ratio (e.g., a fraction) of infrared included in the incident light IL may be greater than that of infrared included in the first reflected light RL1. Therefore, when the incident light IL passes through the prism 100, the first reflected light RL1 including a lower ratio of infrared may be generated. In addition, a ratio of infrared included in the first reflected light RL1 may be less than that of infrared included in the second reflected light RL2.

A refractive index of the prism 100 may be greater than that of outside, e.g., an exterior of, the prism 100. More specifically, the refractive index of the prism 100 may be greater than that of a material in co, e.g., direct, contact with the reflective face 100F2 of the prism 100 and arranged outside the prism 100. In order for at least a part of the incident light IL to be totally reflected from the reflective face 100F2, a first relative refractive index as a ratio of a refractive index inside the prism 100 to the refractive index outside the prism 100, must be greater than \sqrt{ }2. More specifically, the first relative refractive index of the prism 100 as a ratio of the refractive index inside the prism 100 to a refractive index of a material in contact with the reflective face 100F2 and outside the prism 100, must be greater than \sqrt{ }2. For example, when the first relative refractive index is greater than about \sqrt{ }2 and less than about 1.5, the first reflected light RL1 and the second reflected light RL2 may diverge from the reflective face 100F2 and may travel in different directions. For example, the first relative refractive index may be about 1.42 to about 1.46. In the current specification, the refractive index refers to an absolute refractive index.

According to an embodiment, the absolute refractive index of the prism 100 may be about \sqrt{ }2 to about 1.5. When the prism 100 is placed in a vacuum or in air, because the absolute refractive index of the vacuum or air outside the prism 100 in contact with the reflective face 100F2 is close to 1, the absolute refractive index of the prism 100 may be determined as about \sqrt{ }2 to about 1.5.

For example, the prism 100 may include fused silica with a refractive index of about 1.46, low refractive glass with a refractive index of about 1.42 to about 1.46, and/or calcium fluoride (CaF₂) with a refractive index of about 1.43. The prism 100 may be formed of a material with an absolute refractive index of about \sqrt{ }2 to about 1.5.

In addition, in order to have visible light totally reflected from the reflective face 100F2 and to prevent at least a part of infrared from being totally reflected, because a difference in refractive index between visible light and infrared must be large depending on the wavelength of light, the prism 100 may include a material with an Abbe number of less than about 30. The smaller the Abbe number, the larger the difference in refractive index in accordance with the wavelength. When the Abbe number of the prism 100 is less than about 30, the incident light IL with a short wavelength may be totally reflected from the reflective face 100F2, and at least a part of the incident light IL with a long wavelength may not be totally reflected from the reflective face 100F2. Therefore, visible light may be totally reflected from the reflective face 100F2 of the prism 100, and at least a part of infrared may not be totally reflected from the reflective face 100F2.

The Abbe number may be calculated by the following Equation 1.

$${V}_{d} = \frac{{n}_{d} - 1}{{n}_{F} - {n}_{C}} \qquad [ Equation 1 ]$$

In Equation 1, above, V_{d} refers to the Abbe number, n_{d} refers to a refractive index of light with a wavelength of about 587.6 nm, n_{F} refers to a refractive index of light with a wavelength of about 486.1 nm, and n_{C} refers to a refractive index of light with a wavelength of about 656.3 nm.

A common prism includes a material with a refractive index of about 1.5 or more, so that both visible and infrared may be totally reflected from a reflective face of the prism. Reflected light passing through the prism may be incident on a light receiving system. However, in order to separate visible light from infrared, the light receiving system may be increased in size to accommodate for additional elements, and miniaturization of an electronic device including a prism may be complex.

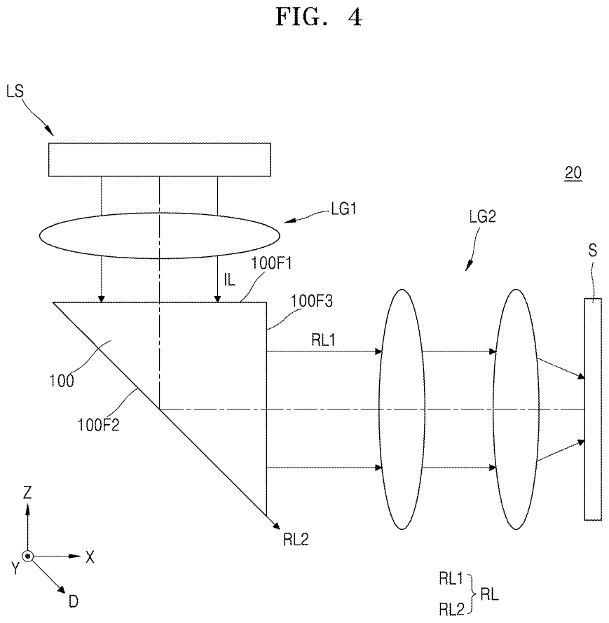

In contrast, because the prism 100 according to embodiments includes a material with the first relative refractive index of about \sqrt{ }2 to about 1.5, visible light may be totally reflected from the reflective face 100F2, and at least a part of infrared may not be totally reflected from the reflective face 100F2, e.g., so visible light and infrared are at least partially separated from each other inside the prism 100 (rather than outside the prism). A part of the infrared may pass through the reflective face 100F2 or may move along the reflective face 100F2. Therefore, because a ratio of infrared in the reflected light RL and/or the first reflected light RL1 passing through the prism 100 is reduced, sizes of components of the light receiving system S (refer to FIG. 4) for removing infrared are reduced, thereby facilitating miniaturization of the light receiving system S (refer to FIG. 4). Therefore, an electronic device including the prism 100 may be easily miniaturized.

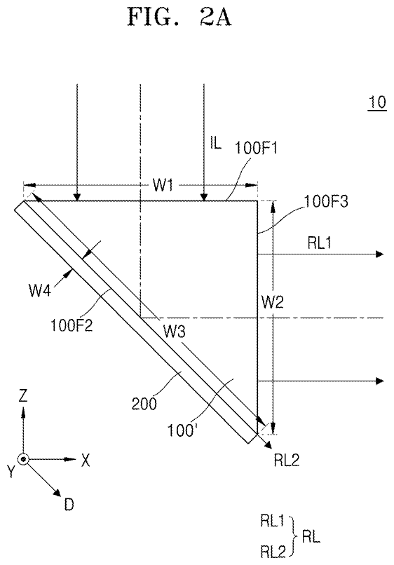

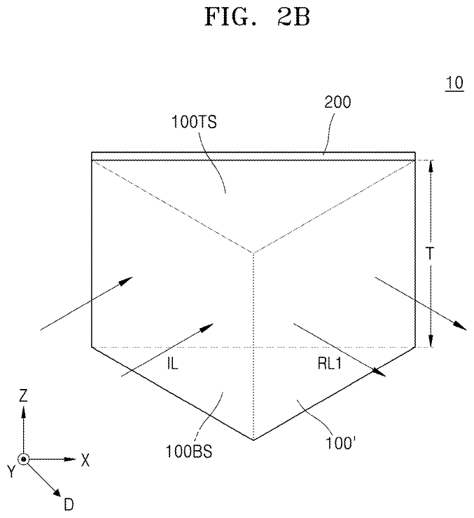

FIG. 2A is a plan view illustrating an optical system 10 according to an embodiment, and FIG. 2B is a perspective view illustrating the optical system 10 according to an embodiment. In FIGS. 2A and 2B, directions of movements of light are marked with arrows.

Referring to FIGS. 2A and 2B, the optical system 10 may include a prism 100′ and a coating layer 200 attached to the reflective face 100F2 of the prism 100′. The prism 100′ in FIGS. 2A and 2B has a same shape as the prism 100 of FIGS. 1A and 1B, but includes a different material, in accordance with the coating layer 200 thereon, as will be described hereinafter.

The coating layer 200 may be formed, e.g., only, on the reflective face 100F2 of the prism 100′. For example, the coating layer 200 may coat continuously the entirety of the reflective face 100F2 of the prism 100′. The coating layer 200 may absorb infrared that is not totally reflected from the reflective face 100F2. The refractive index of the prism 100′ may be greater than that of the coating layer 200. As described above, in order to separate visible light from infrared, a second relative refractive index of the prism 100′ as the ratio of the refractive index inside the prism 100′ to the refractive index of the material in contact with the reflective face 100F2 and outside the prism 100′, must be about \sqrt{ }2 to about 1.5. That is, the second relative refractive index as a ratio of the refractive index of the prism 100 to the refractive index of the coating layer 200, may be about \sqrt{ }2 to about 1.5. For example, the second relative refractive index may be about 1.42 to about 1.46.

For example, the coating layer 200 may include a material with a low refractive index, and the prism 100 may include a material with a high refractive index. For example, the coating layer 200 may include magnesium fluoride (MgF₂) with a refractive index of about 1.38, cryolite with a refractive index of about 1.35, silicon oxide with a refractive index of about 1.46, calcium fluoride (CaF₂) with a refractive index of about 1.8, yttrium oxide (Y₂O₃) with a refractive index of about 1.8, and/or yttrium aluminum garnet (YAG) with a refractive index of about 1.83. For example, the coating layer 200 may include glass and/or transparent polymer.

For example, the prism 100′ may include high refractive glass with a refractive index of about 2.0, ruthenium aluminum garnet with a refractive index of about 2.14, zirconium oxide (ZrO₂) with a refractive index of about 2.16, moissanite with a refractive index of about 2.6 to about 2.7, and/or tantalum pentoxide (Ta₂O₅) with a refractive index of about 2.1.

According to an embodiment, the material of the prism 100′ may be selected in accordance with the refractive index of the coating layer 200, and/or the material of the coating layer 200 may be selected in accordance with the refractive index of the prism 100′, e.g., so the second relative refractive index of the prism 100′ with the coating layer 200 is about √2 to about 1.5. For example, when the prism 100 includes moissanite with a refractive index of about 2.6 to about 2.7, the coating layer 200 may include Y₂O₃ with a refractive index of about 1.8 and/or YAG with a refractive index of about 1.83.

When the second relative refractive index is about \sqrt{ }2 to about 1.5, visible light is totally reflected and passes through the exit face 100F3. However, at least a part of infrared may travel in the third direction (the D direction) in which the reflective face 100F2 extends and/or may be incident on the coating layer 200. The coating layer 200 may absorb infrared incident thereon.

When the coating layer 200 is formed on the reflective face 100F2 of the prism 100, the second relative refractive index of the prism 100′ as the ratio of the refractive index inside the prism 100′ to the refractive index of the coating layer 200 may be easily controlled to be about \sqrt{ }2 to about 1.5. In addition, at least a part of infrared may be absorbed by the coating layer 200 so that reliability of the optical system 10 may increase. That is, at least a part of the second reflected light RL2 may be absorbed by the coating layer 200 so that the reliability of the optical system 10 may increase.

The coating layer 200 may have a fourth width W4 in a direction perpendicular to the reflective face 100F2. The coating layer 200 may have a same, e.g., constant, fourth width W4 in the direction perpendicular to the reflective face 100F2, and may be formed, e.g., directly, on the reflective face 100F2. For example, the coating layer 200 may be conformally coated on the reflective face 100F2. For example, the fourth width W4 may be about 30 μm to about 100 μm, e.g., about 40 μm to about 70 μm.

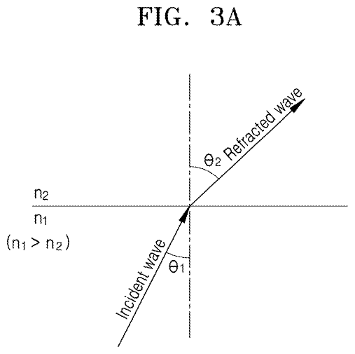

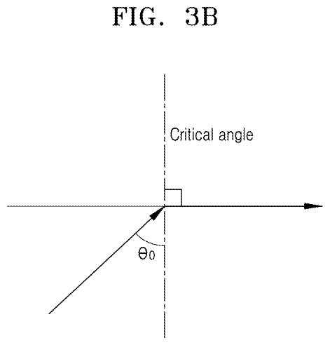

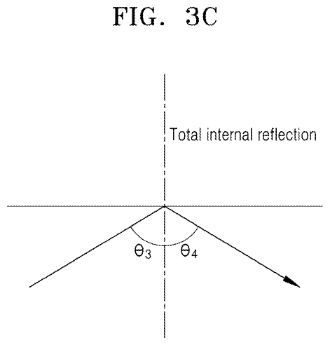

FIGS. 3A to 3C are views describing a law of total internal reflection according to an embodiment. FIGS. 3A to 3C illustrate the law of total internal reflection referenced for better understanding of the optical system 10 or the prism 100 of FIGS. 1A to 2B. In the optical system 10 or the prism 100, a material with a refractive index lower than that of the prism 100 (or prism 100′) may be placed outside the prism 100 in order to increase the ratio of visible light of the first reflected light RL1. More specifically, in the optical system 10 or the prism 100, a material in contact with the reflective face 100F2 of the prism 100 and with a refractive index lower than that of the prism 100 may be placed in order to increase the ratio of visible light in the first reflected light RL1.

Referring to FIG. 3A, when light travels from a material with a high refractive index to a material with a low refractive index, an angle of refraction may always be greater than an angle of incidence. For example, a first refractive index n₁ of a first material may be greater than a second refractive index n₂ of a second material. When light travels from the first material toward the second material, the angle of incidence may be smaller than the angle of refraction. The angle of incidence and the angle of refraction may be calculated by Snell's law.

Snell's law may be calculated by the following equation 2.

n₁ sin θ₁=n₂ sin θ₂ [Equation 2]

In Equation 2, above, n₁ refers to the refractive index of the first material, θ₁ refers to the angle of incidence, n₂ refers to the refractive index of the second material, and θ₂ refers to the angle of refraction.

Referring to FIG. 3B, when the angle of incidence increases so that the angle of refraction becomes 90°, the angle of incidence may be the critical angle (θ₀). That is, when the angle of incidence is the critical angle (θ₀), the reflected light RL travels along an interface between the first material and the second material. The critical angle (θ₀) may be obtained by substituting 90° for θ₂ of Snell's law (i.e., in Equation 2 above). That is, the critical angle (θ₀) may be calculated by the following Equation 3.

$${θ}_{0} = arcsin ( \frac{{n}_{2}}{{n}_{1}} ) \qquad [ Equation 3 ]$$

In Equation 3, above, θ₀ refers to the critical angle, n₁ refers to the refractive index of the first material, and n₂ refers to the refractive index of the second material.

Referring to FIG. 3C, when the angle of incidence (θ₃) is greater than the critical angle (θ₀ in FIG. 3B), the incident light IL may be totally reflected from the interface between the first material and the second material. At this time, the angle of incidence (θ₃) may be equal to an angle of reflection (θ₄).

FIG. 4 is a schematic planar view illustrating an optical system 20 according to an embodiment. In FIG. 4, directions of movement of light are marked with arrows.

Referring to FIGS. 1A, 1B, and 4, the optical system 20 may include a first lens group LG1 close to a light source LS, and a second lens group LG2 close to the prism 100 and the light receiving system S. For example, the first lens group LG1 may be positioned between the light source LS and the prism 100.

The first lens group LG1 may include one or more lenses with positive refractive power and/or one or more lenses with negative refractive power. The first lens group LG1 may change a path of light generated by the light source LS so that the light generated by the light source LS may be incident perpendicularly to the incident face 100F1 of the prism 100. The first lens group LG1 may change a path of the incident light IL so that the light generated by the light source LS may be incident perpendicularly to the incident face 100F1 of the prism 100. For example, the first lens group LG1 may direct the light generated by the light source LS to the incident face 100F1 of the prism 100. The first lens group LG1 may include at least one of a convex lens, a Fresnel lens, a holographic optical element (HOE), a diffraction optical element (DOE), a liquid crystal lens, and an optical element serving as a lens. In addition, the first lens group LG1 may include a film serving as a lens.

It is illustrated in FIG. 4 that the first lens group LG1 includes only one lens. However, embodiments are not limited thereto, e.g., the first lens group LG1 may include two or more lenses.

The prism 100 may include the incident face 100F1, the reflective face 100F2, and the exit face 100F3. For example, the incident face 100F1 may refer to a face closest to the first lens group LG1 and/or the light source LS among the plurality of faces of the prism 100, e.g., the prism 100 may be positioned to have the incident face 100F1 face the first lens group LG1. For example, the exit face 100F3 may refer to a face closest to the second lens group LG2 and/or an image sensor among the plurality of faces of the prism 100, e.g., the prism 100 may be positioned to have the exit face 100F3 face the second lens group LG2. The reflective face 100F2 refers to a face of the prism 100 that is other than the top face 100TS (e.g., a top surface), the bottom face 100BS, the incident face 100F1, and the exit face 100F3 among the plurality of faces of the prism 100.

For example, the first relative refractive index as the ratio of the refractive index inside the prism 100 to the refractive index outside the prism 100, may be greater than about \sqrt{ }2 and less than about 1.5. More specifically, the first relative refractive index of the prism 100 as the ratio of the refractive index inside the prism 100 to the refractive index of the material in contact with the reflective face 100F2 and outside the prism 100, may be greater than about \sqrt{ }2 and less than about 1.5. When the first relative refractive index is about \sqrt{ }2 to about 1.5, a ratio of infrared to light reflected from the prism 100 may be reduced. That is, when a relative refractive index of the prism 100 is about \sqrt{ }2 to about 1.5, a ratio of infrared to the first reflected light RL1 may be reduced.

Therefore, the ratio of visible light included in the incident light IL may be less than that of visible light included in the first reflected light RL1. Therefore, when the incident light IL passes through the prism 100, the first reflected light RL1 including a higher ratio of visible light may be generated. In addition, the ratio of visible light included in the first reflected light RL1 may be greater than that of visible light included in the second reflected light RL2.

In other words, the ratio of infrared included in the incident light IL may be greater than that of infrared included in the first reflected light RL1. Therefore, when the incident light IL passes through the prism 100, the first reflected light RL1 including a lower ratio of infrared may be generated. In addition, the ratio of infrared included in the first reflected light RL1 may be less than that of infrared included in the second reflected light RL2.

Therefore, the ratio of visible light of the first reflected light RL1 incident on the light receiving system S may increase, and the ratio of infrared to the first reflected light RL1 may be reduced.

The second lens group LG2 may include one or more lenses with positive refractive power and/or one or more lenses with negative refractive power. The second lens group LG2 may be similar to the first lens group LG1.

The light receiving system S may include, e.g., a photodiode. The light receiving system S may include, e.g., an image sensor including an image semiconductor chip. The image sensor may include a cover glass for separating infrared. For example, the cover glass may include a material with a high light transmittance. For example, the cover glass may include transparent glass or transparent polymer. For example, the cover glass may further include a filter for passing or blocking light in a specific wavelength band. For example, the cover glass may include an IR cut-off filter (IRCF) and/or a blue glass (or a blue filter) for an infrared filter. Because the ratio of infrared in the reflected light RL incident on the light receiving system S is reduced by controlling the refractive index of the prism 100, a size of the cover glass of the light receiving system S may be reduced. For example, because the ratio of infrared in the reflected light RL incident on the light receiving system S is reduced by controlling the refractive index of the prism 100, a thickness of the cover glass of the light receiving system S may be reduced. That is, the size of the light receiving system S may be reduced. According to an embodiment, in a folded optical system, the incident light IL

incident on the prism 100 and the light incident on the light receiving system S may form an angle of about 90°. In another embodiment, the incident light IL incident on the prism 100 and the light incident on the light receiving system S may form an angle other than about 90°.

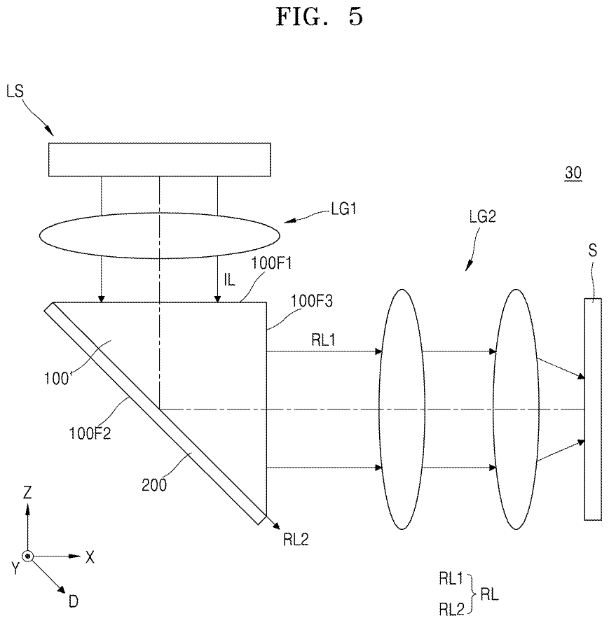

FIG. 5 is a schematic planar view illustrating an optical system 30 according to an embodiment. In FIG. 5, directions of movement of light are marked with arrows.

Referring to FIGS. 2A, 2B, and 5, the optical system 30 may include the first lens group LG1 close to the light source LS, the prism 100′ with the coating layer 200, the second lens group LG2 close to the prism 100′, and the light receiving system S.

The first lens group LG1, the second lens group LG2, and the light receiving system S may be substantially the same as those in FIG. 4. The prism 100′ and the coating layer 200 may be substantially the same as those in FIGS. 2A and 2B.

The prism 100′ may include the incident face 100F1, the reflective face 100F2, and the exit face 100F3. For example, the incident face 100F1 refers to a face closest to the first lens group LG1 and/or the light source LS among the plurality of faces of the prism 100′, and the exit face 100F3 refers to a face closest to the second lens group LG2 and/or an image sensor among the plurality of faces of the prism 100. The reflective face 100F2 refers to a face of the prism 100′ other than the top face 100TS, the bottom face 100B S, the incident face 100F1, and the exit face 100F3 among the plurality of faces of the prism 100′.

The coating layer 200 may be formed on the reflective face 100F2 of the prism 100′. That is, the second relative refractive index as the ratio of the refractive index of the prism 100 to the refractive index of the coating layer 200, may be greater than about \sqrt{ }2 and less than about 1.5. When the second relative refractive index is about \sqrt{ }2 to about 1.5, a ratio of infrared to light reflected from the prism 100 may be reduced. That is, when the second relative refractive index as the ratio of the refractive index of the prism 100 to the refractive index of the coating layer 200 is about \sqrt{ }2 to about 1.5, the ratio of infrared to the first reflected light RL1 may be reduced.

According to an embodiment, in a folded optical system, the incident light IL incident on the prism 100′ and the light incident on the light receiving system S may form an angle of about 90°. That is, the incident light IL incident on the prism 100′ and the first reflected light RL1 may form an angle of about 90°. For example, the incident light IL incident on the prism 100′ and the second reflected light RL2 may form an angle other than about 90°. In another embodiment, the incident light IL incident on the prism 100′ and the light incident on the light receiving system S may form an angle other than about 90°.

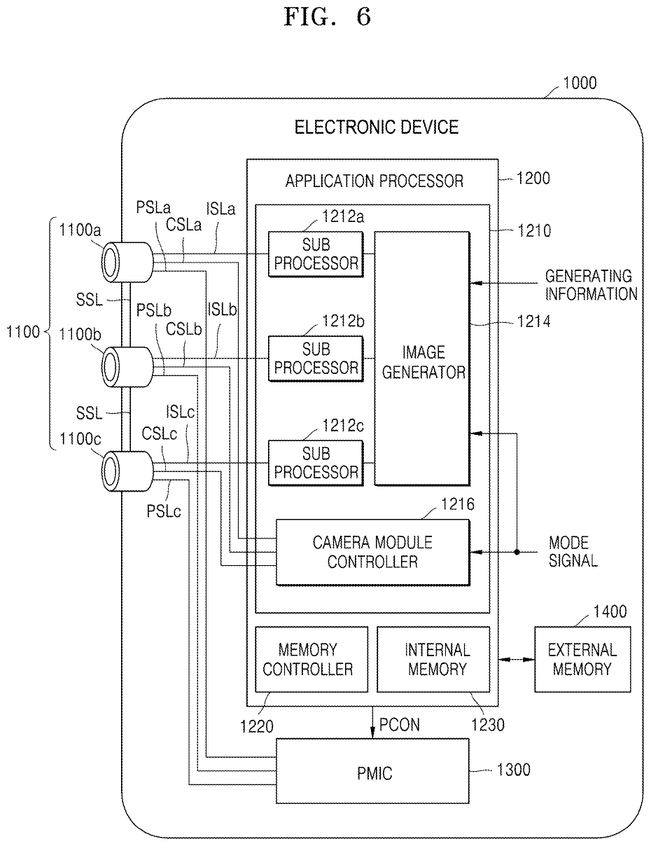

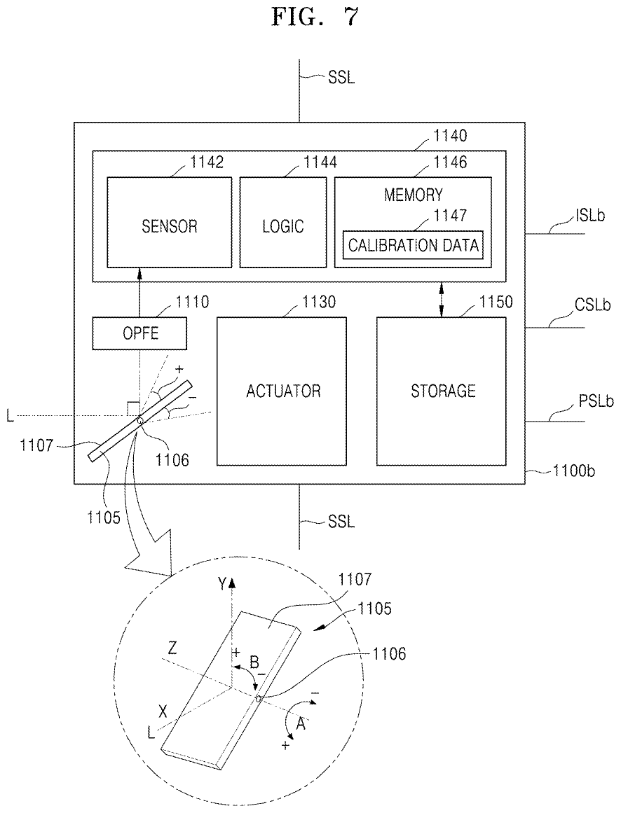

FIG. 6 is a block diagram of an electronic device 1000 including a multi-camera module, and FIG. 7 is a detailed block diagram of the multi-camera module of FIG. 6.

Referring to FIG. 6, the electronic device 1000 may include a camera module group 1100, an application processor 1200, a power management integrated circuit (PMIC) 1300, and an external memory 1400.

The camera module group 1100 may include a plurality of camera modules 1100a, 1100b, and 1100c. It is illustrated in FIG. 6 that three camera modules 1100a, 1100b, and 1100c are arranged. However, embodiments are not limited thereto, e.g., the camera module group 1100 may include only two camera modules or n (n is a natural number greater than or equal to 4) camera modules.

Referring to FIG. 7, the camera module 1100b may include a prism 1105, an optical path folding element (OPFE) 1110, an actuator 1130, an image sensing device 1140, and a storage 1150.

Here, a configuration of the camera module 1100b will be described in more detail. However, the following description may also be applied to the other camera modules 1100a and 1100c according to embodiments.

The prism 1105 may include a reflective face 1107 of a light reflective material to change a path of light L incident from the outside. The prism 1105 may include the prism 100 described above. Alternatively, the prism 1105 may include the optical system 10 described above.

In some embodiments, the prism 1105 may change the path of the light L incident in the first direction (the X direction) to the second direction (the Y direction) perpendicular to the first direction (the X direction). In addition, the prism 1105 may rotate the reflective face 1107 of the light reflective material in an A direction around a central axis 1106, or may rotate the central axis 1106 in a B direction to change the path of the light L incident in the first direction (the X direction) to the second direction (the Y direction) perpendicular to the first direction (the X direction). At this time, the OPFE 1110 may also move in a vertical direction (a Z direction) perpendicular to the first direction (the X direction) and the second direction (the Y direction).

In some embodiments, as illustrated in FIG. 7, the maximum rotation angle in the A direction of the prism 1105 is about 15° or less in a positive (+) A direction and may be greater than about 15° in a negative (−) A direction. However, embodiments are not limited thereto.

In some embodiments, the prism 1105 may move at about 20°, at about 10° to about 20°, or at about 15° to about 20° in a positive (+) or negative (−) B direction. Here, the prism 1105 may move at the same angle or at a similar angle in a range of about 1° in the positive (+) or negative (−) B direction.

In some embodiments, the prism 1105 may move the reflective face 1107 of the light reflective material in the vertical direction (the Z direction) parallel to a direction in which the central axis 1106 extends.

The OPFE 1110 may include, e.g., an optical lens including m (m is a natural number) groups. M lenses may move in the second direction (the Y direction) to change an optical zoom magnification of the camera module 1100b. For example, when a basic optical zoom magnification of the camera module 1100b is z, in a case in which the m groups of optical lenses included in the OPFE 1110 are moved, the optical zoom magnification of the camera module 1100b may be changed to an optical zoom magnification of 3z, 5z, or more.

The actuator 1130 may move the OPFE 1110 or the optical lens to a specific position. For example, the actuator 1130 may adjust the position of the optical lens so that an image sensor 1142 is positioned at a focal length of the optical lens for accurate sensing.

The image sensing device 1140 may include the image sensor 1142, a control logic 1144, and a memory 1146. The image sensor 1142 may sense an image to be sensed by using the light L provided through the optical lens. The control logic 1144 may control the overall operation of the camera module 1100b. For example, the control logic 1144 may control an operation of the camera module 1100b in accordance with a control signal provided through a control signal line CSLb.

The memory 1146 may store information required for the operation of the camera module 1100b, e.g., calibration data 1147. The calibration data 1147 may include information required for the camera module 1100b to generate image data by using the light L provided from the outside. The calibration data 1147 may include, e.g., information on the degree of rotation described above, information on the focal length, and information on an optical axis. When the camera module 1100b is a multi-state camera in which the focal length varies in accordance with the position of the optical lens, the calibration data 1147 may include information on a focal length of each position (or state) of the optical lens and auto-focusing.

The storage 1150 may store the image data sensed by the image sensor 1142. The storage 1150 may be arranged outside the image sensing device 1140, and may be stacked with a sensor chip constituting the image sensing device 1140. In some embodiments, the storage 1150 may be electrically erasable programmable read-only memory (EEPROM).

Referring to FIGS. 6 and 7, in some embodiments, each of the plurality of camera modules 1100a, 1100b, and 1100c may include the actuator 1130. Therefore, the plurality of camera modules 1100a, 1100b, and 1100c may include the same or different calibration data 1147 in accordance with an operation of the actuator 1130 included in each of the plurality of camera modules 1100a, 1100b, and 1100c.

In some embodiments, one of the plurality of camera modules 1100a, 1100b, and 1100c (e.g., camera module 1100b) may be a folded lens-type camera module including the prism 1105 and the OPFE 1110 described above, and the remaining camera modules (e.g., camera modules 1100a and 1100c) may be vertical-type camera modules without the prism 1105 and the OPFE 1110.

In some embodiments, one of the plurality of camera modules 1100a, 1100b, and 1100c (e.g., camera module 1100c) may be a vertical-type depth camera extracting depth information by using infrared. In this case, the application processor 1200 may generate a three-dimensional (3D) depth image by merging image data received from the depth camera with image data received from another camera module (e.g., camera modules 1100a or 1100b).

In some embodiments, at least two of the plurality of camera modules 1100a, 1100b, and 1100c (e.g., camera modules 1100a and 1100b) may have different fields of view (viewing angles). In this case, the at least two (e.g., 1100a and 1100b) of the plurality of camera modules 1100a, 1100b, and 1100c may have different optical lenses.

In addition, in some embodiments, the plurality of camera modules 1100a, 1100b, and 1100c may have different viewing angles. In this case, the plurality of camera modules 1100a, 1100b, and 1100c may have different optical lenses.

In some embodiments, the plurality of camera modules 1100a, 1100b, and 1100c may be spaced apart from one another. That is, instead of dividing a sensing area of the image sensor 1142 into a plurality of areas to be used by the plurality of camera modules 1100a, 1100b, and 1100c, the image sensor 1142 may be arranged in each of the plurality of camera modules 1100a, 1100b, and 1100c.

Referring to FIG. 6 again, the application processor 1200 may include an image processing device 1210, a memory controller 1220, and internal memory 1230. The application processor 1200 may be separate from the plurality of camera modules 1100a, 1100b, and 1100c. For example, the application processor 1200 and the plurality of camera modules 1100a, 1100b, and 1100c may be implemented separately by separate semiconductor chips.

The image processing device 1210 may include a plurality of sub-image processors 1212a, 1212b, and 1212c, an image generator 1214, and a camera module controller 1216.

The image processing device 1210 may include the plurality of sub-image processors 1212a, 1212b, and 1212c the number of which corresponds to the number of camera modules 1100a, 1100b, and 1100c.

Image data items generated by the plurality of camera modules 1100a, 1100b, and 1100c may be provided to the plurality of sub-image processors 1212a, 1212b, and 1212c through a plurality of image signal lines ISLa, ISLb, and ISLc separate from one another. For example, the image data generated by the camera module 1100a may be provided to the sub-image processor 1212a through the image signal line ISLa, the image data generated by the camera module 1100b may be provided to the sub-image processor 1212b through the image signal line ISLb, and the image data generated by the camera module 1100c may be provided to the sub-image processor 1212c through the image signal line ISLc. Such image data transmission may be performed by using, e.g., a camera serial interface (CSI) based on the mobile industry processor interface (MIPI).

Meanwhile, in some embodiments, one sub-image processor may be arranged to correspond to a plurality of camera modules. For example, the sub-image processor 1212a and the sub-image processor 1212c may not be separate from each other, but may be integrated into one sub-image processor, and the image data items received from the camera module 1100a and the camera module 1100c may be selected through a selection element (e.g., a multiplexer) to be provided to the integrated sub-image processor.

The image data items provided to the plurality of sub-image processors 1212a, 1212b, and 1212c may be provided to the image generator 1214. The image generator 1214 may generate an output image by using the image data items received from the plurality of sub-image processors 1212a, 1212b, and 1212c in accordance with image creation information or a mode signal.

Specifically, the image generator 1214 may merge at least some of the image data items generated by the plurality of camera modules 1100a, 1100b, and 1100c having different viewing angles to generate the output image in accordance with the image creation information or the mode signal. In addition, the image generator 1214 may generate the output image by selecting one of the image data items generated by the plurality of camera modules 1100a, 1100b, and 1100c having different viewing angles in accordance with the image creation information or the mode signal.

In some embodiments, the image creation information may include a zoom signal or a zoom factor. In addition, in some embodiments, the mode signal may be based on, e.g., a mode selected by a user.

When the image creation information is the zoom signal (the zoom factor) and the plurality of camera modules 1100a, 1100b, and 1100c have different fields of view (viewing angles), the image generator 1214 may perform different operations in accordance with a type of the zoom signal. For example, when the zoom signal is a first signal, after merging the image data output from the camera module 1100a with the image data output from the camera module 1100c, the output image may be generated by using an image signal obtained by merging the image data output from the camera module 1100a with the image data output from the camera module 1100c and the image data output from the camera module 1100b that is not used for merging the image data output from the camera module 1100a with the image data output from the camera module 1100c. When the zoom signal is a second signal different from the first signal, the image generator 1214 may generate the output image by selecting one of the image data items output from the plurality of camera modules 1100a, 1100b, and 1100c without merging the image data output from the camera module 1100a with the image data output from the camera module 1100c. However, embodiments are not limited thereto. A method of processing the image data may vary as occasion demands.

In some embodiments, the image generator 1214 may receive a plurality of image data items having different exposure times from at least one of the plurality of sub-image processors 1212a, 1212b, and 1212c and may perform HDR processing on the plurality of image data items to generate merged image data with an increased dynamic range.

The camera module controller 1216 may provide control signals to the plurality of camera modules 1100a, 1100b, and 1100c. The control signals generated by the camera module controller 1216 may be provided to the plurality of camera modules 1100a, 1100b, and 1100c through a plurality of control signal lines CSLa, CSLb, and CSLc separate from one another.

One of the plurality of camera modules 1100a, 1100b, and 1100c may be designated as a master camera module (for example, 1100b) in accordance with the image creation information including the zoom signal or the mode signal, and the remaining camera modules (for example, 1100a and 1100c) may be designated as slave camera modules. Such information may be included in the control signals and may be provided to the plurality of camera modules 1100a, 1100b, and 1100c through the plurality of control signal lines CSLa, CSLb, and CSLc separate from one another.

A camera module operating as a master camera module or a slave camera module may vary in accordance with the zoom factor or the mode signal. For example, when the viewing angle of the camera module 1100a is greater than that of the camera module 1100b and the zoom factor represents a low zoom magnification, the camera module 1100b may operate as a master camera and the camera module 1100a may operate as a slave camera. To the contrary, when the zoom factor represents a high zoom magnification, the camera module 1100a may operate as a master camera and the camera module 1100b may operate as a slave camera.

In some embodiments, the control signals provided from the camera module controller 1216 to the plurality of camera modules 1100a, 1100b, and 1100c may include a sync enable signal. For example, when the camera module 1100b is a master camera and the camera modules 1100a and 1100c are slave cameras, the camera module controller 1216 may transmit the sync enable signal to the camera module 1100b. The camera module 1100b receiving the sync enable signal may generate a sync signal based on the received sync enable signal and may provide the generated sync signal to the camera modules 1100a and 1100c through a sync signal line SSL. The camera module 1100b and the camera modules 1100a and 1100c may transmit the image data items to the application processor 1200 in synchronization with the sync signal.

In some embodiments, the control signals provided from the camera module controller 1216 to the plurality of camera modules 1100a, 1100b, and 1100c may include mode information in accordance with the mode signal. Based on the mode information, the plurality of camera modules 1100a, 1100b, and 1100c may operate in a first operation mode and a second operation mode in relation to a sensing speed.

In the first operation mode, the plurality of camera modules 1100a, 1100b, and 1100c may generate an image signal at a first speed (for example, at a first frame rate), may encode the image signal at a second speed higher than the first speed (for example, at a second frame rate higher than the first frame rate), and may transmit the encoded image signal to the application processor 1200.

The application processor 1200 may store the received image signal, that is, the encoded image signal, in the internal memory 1230 in the application processor 1200 or the external memory 1400 outside the application processor 1200, may read the encoded image signal from the internal memory 1230 or the external memory 1400 to decode the encoded image signal, and may display image data generated based on the decoded image signal. For example, a corresponding sub-image processor among the plurality of sub-image processors 1212a, 1212b, and 1212c of the image processing device 1210 may decode the encoded image signal, and may perform image processing on the decoded image signal.

In the second operation mode, the plurality of camera modules 1100a, 1100b, and 1100c may generate an image signal at a third speed lower than the first speed (for example, at a third frame rate lower than the first frame rate), and may transmit the image signal to the application processor 1200. The image signal provided to the application processor 1200 may be an unencoded signal. The application processor 1200 may perform image processing on the received image signal or may store the image signal in the internal memory 1230 or the external memory 1400.

The PMIC 1300 may supply power, e.g., a power voltage, to each of the plurality of camera modules 1100a, 1100b, and 1100c. For example, under control by the application processor 1200, the PMIC 1300 may supply first power to the camera module 1100a through a power signal line PSLa, may supply second power to the camera module 1100b through a power signal line PSLb, and may supply third power to the camera module 1100c through a power signal line PSLc.

The PMIC 1300 may generate power components corresponding to the plurality of camera modules 1100a, 1100b, and 1100c and may adjust levels of the power components in response to a power control signal PCON from the application processor 1200. The power control signal PCON may include a power adjustment signal for each operation mode of the plurality of camera modules 1100a, 1100b, and 1100c. For example, the operation mode may include a low power mode. At this time, the power control signal PCON may include information on a camera module operating in the low power mode and a set power level. Levels of the power components provided to the plurality of camera modules 1100a, 1100b, and 1100c may be the same or different from one another. In addition, the levels of the power components may dynamically change.

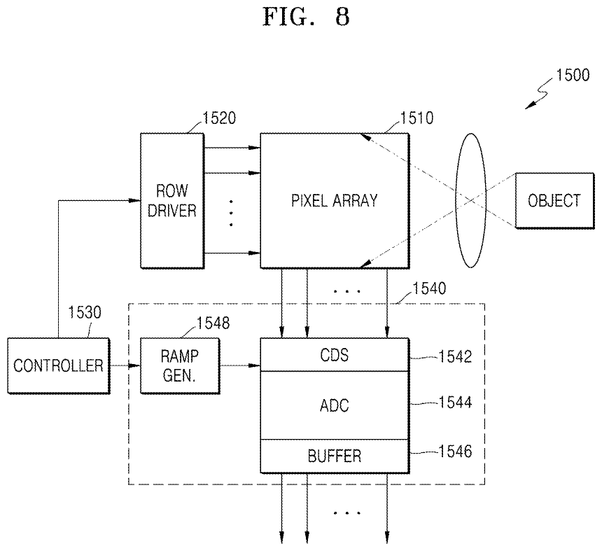

FIG. 8 is a block diagram illustrating a configuration of an image sensor 1500 according to an embodiment.

Referring to FIG. 8, the image sensor 1500 may include a pixel array 1510, a controller 1530, a row driver 1520, and a pixel signal processor 1540.

The image sensor 1500 may include the prism 100 described above or at least one of the optical systems 10, 20, and 30. The pixel array 1510 may include a plurality of two-dimensionally arranged unit pixels, and each unit pixel may include a photoelectric conversion element. The photoelectric conversion element absorbs light to generate photocharges, and an electrical signal (an output voltage) in accordance with the generated photocharges may be provided to the pixel signal processor 1540 through a vertical signal line.

The unit pixels included in the pixel array 1510 may provide output voltages one at a time in units of rows so that unit pixels belonging to one row of the pixel array 1510 may be simultaneously activated by a selection signal output by the row driver 1520. A unit pixel belonging to a selected row may provide an output voltage in accordance with the absorbed light to an output line of a corresponding column.

The controller 1530 may control the row driver 1520 so that the pixel array 1510 absorbs light to accumulate photocharges, temporarily stores the accumulated photocharges, and outputs an electrical signal in accordance with the stored photocharges to the outside of the pixel array 1510. In addition, the controller 1530 may control the pixel signal processor 1540 to measure the output voltage provided by the pixel array 1510.

The pixel signal processor 1540 may include a correlated double sampler (CDS) 1542, an analog-to-digital converter (ADC) 1544, and a buffer 1546. The CDS 1542 may sample and hold the output voltage provided by the pixel array 1510.

The CDS 1542 may double-sample a specific noise level and a level corresponding to the generated output voltage, and may output a level corresponding to a difference between the specific noise level and the level corresponding to the generated output voltage. In addition, the CDS 1542 may receive ramp signals generated by a ramp signal generator 1548 and may compare the ramp signals with one another to output a comparison result.

The ADC 1544 may convert analog signals corresponding to levels received from the CDS 1542 into digital signals. The buffer 1546 may latch the digital signals, and the latched digital signals may be sequentially output to the outside of the image sensor 1500 to be transmitted to an image processor.

By way of summation and review, embodiments relate to a prism with increased reliability and an optical system including the same. That is, according to embodiments, a prism, e.g., selectively, separating visible light of incident light from infrared is provided so that a smaller ratio of infrared is incident on a light receiving system. Such prism may further include a coating layer on its reflective face, so that infrared that is not totally reflected is absorbed by the coating layer. Therefore, reliability of an electronic device including the prism and the optical system including the same is increased.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A prism, comprising:
an incident face on which an incident light is to be incident, the incident light including a visible light and an infrared;
a reflective face from which at least a part of the incident light is reflected; and
an exit face from which a reflected light is emitted,
wherein the visible light of the incident light is totally reflected from the reflective face, and only a part of the infrared of the incident light is totally reflected from the reflective face.

2. The prism as claimed in claim 1, wherein a ratio of a refractive index of the prism to a refractive index outside the prism is about \sqrt{ }2 to about 1.5.

3. The prism as claimed in claim 1, wherein a ratio of a refractive index of the prism to a refractive index of a material in contact with the reflective face and outside the prism, is about \sqrt{ }2 to about 1.5.

4. The prism as claimed in claim 1, wherein an absolute refractive index of the prism is about \sqrt{ }2 to about 1.5.

5. The prism as claimed in claim 1, wherein each of an angle between the incident face and the reflective face and an angle between the reflective face and the exit face is about 45°.

6. The prism as claimed in claim 1, wherein a direction of movement of the incident light and a direction of movement of the visible light in the reflected light form about 90° therebetween.

7. The prism as claimed in claim 1, wherein the prism includes a material with an Abbe number of about 30 or less.

8. An optical system, comprising:
a prism including a top surface, a bottom surface, an incident face on which an incident light including visible light and infrared is incident, a reflective face from which at least a part of the incident light is reflected, and an exit face from which a reflected light is emitted; and
a coating layer outside the prism and in contact with the reflective face,
wherein the visible light of the incident light is totally reflected from the reflective face, and only a part of the infrared of the incident light is totally reflected from the reflective face.

9. The optical system as claimed in claim 8, wherein a ratio of a refractive index of the prism to a refractive index of the coating layer is about \sqrt{ }2 to about 1.5.

10. The optical system as claimed in claim 9, wherein:
the refractive index of the coating layer is about 1.35 to about 2, and
the refractive index of the prism is about 2 to about 3.

11. The optical system as claimed in claim 8, wherein:
each of a first width of an edge at which the top surface meets the incident face and a second width of an edge at which the top surface meets the exit face is about 3 mm to about 10 mm, and
a third width of an edge at which the top surface meets the reflective face is about 4 mm to about 14 mm.

12. The optical system as claimed in claim 8, wherein the coating layer has a fourth width in a direction perpendicular to the reflective face, the fourth width being about 30 μm to about 100 μm.

13. The optical system as claimed in claim 8, wherein a part of the infrared passing through the reflective face is absorbed by the coating layer.

14. An optical system, comprising:
a prism including a top surface, a bottom surface, an incident face on which an incident light including a visible light and an infrared is incident, a reflective face from which at least a part of the incident light is reflected, and an exit face from which a reflected light is emitted;
a first lens group including at least one lens with a positive refractive power or at least one lens with a negative refractive power, the first lens group being configured to direct light of a light source to the prism; and
a second lens group, on which light reflected from the prism is incident, the second lens group including at least one lens with a positive refractive power or at least one lens with a negative refractive power, and configured to direct a reflected light to a light receiving system, wherein the visible light of the incident light is totally reflected from the reflective face, and only a part of the infrared of the incident light is totally reflected from the reflective face.

15. The optical system as claimed in claim 14, wherein a ratio of a refractive index of the prism to a refractive index of a material in contact with the reflective face and outside the prism, is about \sqrt{ }2 to about 1.5.

16. The optical system as claimed in claim 15, further comprising a coating layer arranged outside the prism and in contact with the reflective face, the refractive index of the coating layer being about 1.35 to about 2, and the refractive index of the prism being about 2 to about 3.

17. The optical system as claimed in claim 16, wherein:
each of a first width of an edge at which the top surface meets the incident face and a second width of an edge at which the top surface meets the exit face is about 3 mm to about 10 mm, and
the coating layer has a fourth width in a direction perpendicular to the reflective face, the fourth width being about 30 μm to about 100 μm.

18. The optical system as claimed in claim 14, wherein the reflected light includes:
a first reflected light passing through the exit face; and
a second reflected light that does not pass through the exit face.

19. The optical system as claimed in claim 18, wherein a ratio of the visible light to the incident light is less than a ratio of the visible light to the first reflected light.

20. The optical system as claimed in claim 18, wherein a ratio of the visible light to the first reflected light is greater than a ratio of the visible light to the second reflected light.
